(19) United States
(12) Patent Application Publication
(10) Pub. No.: US 2008/0259841 A1
(43) Pub. Date: Oct. 23, 2008

(54) SUBSCRIPTION AGGREGATION AND LOAD BALANCING IN A BROADBAND ROUTER

(76) Inventor: Parag Deshpande, San Jose, CA (US)

Correspondence Address: MACPHERSON KWOK CHEN & HEID LLP, 2033 GATEWAY PLACE, SUITE 400, SAN JOSE, CA, 95110, US

(21) Appl. No.: 11/736,209

(22) Filed: Apr. 17, 2007

(51) Int. Cl. H04Q 7/00

(52) U.S. Cl. 370/328

(57) ABSTRACT

In one embodiment, a bandwidth aggregation router is provided including a wireless broadband modem interface for communicating with a wireless network, a wired wide area network interface, and a processor configured to aggregate bandwidth from the wireless broadband modem interface and the wired wide area network interface. The router may then efficiently allocate the aggregated bandwidth to at least one device for access to a network.

### TECHNICAL FIELD

The present invention relates generally to network access and routers.

### BACKGROUND

With the expansion of the Internet and desired access to the network, many users now have multiple Internet service subscriptions. One of the Internet service subscriptions may be through a mobile broadband connection card, which provides wireless access utilising a carrier's cellular network (e.g., Sprint, Verizon). Another Internet service subscription may be provided by a wired service such as a digital subscriber line (DSL) (e.g., Earthlink) or cable (e.g., Comcast) via a residential gateway or router.

Typically, at a residence or in an office environment, a user or a plurality of users may use either the wired residential or office Internet subscription or the wireless broadband card connection to access the Internet, thus not optimally utilizing all the Internet bandwidth that has been subscribed to and paid for, being particularly true when multiple users are competing for bandwidth.

### OVERVIEW

In accordance with an embodiment of the present invention, an apparatus is provided, including a wireless broadband modem interface for communicating with a wireless network, a wired wide area network interface, and a processor configured to aggregate bandwidth from the wireless broadband modem interface and the wired wide area network interface.

In accordance with another embodiment of the present invention, another apparatus is provided, including means for providing access to a wireless network, means for providing access to a wired wide area network, means for aggregating bandwidth to access the wireless network and the wired wide area network, and means for allocating aggregated bandwidth to at least one device.

In accordance with another embodiment of the present invention, a method is provided, including providing a bandwidth aggregation router including a wireless broadband modem interface and a wired wide area network interface, operably coupling a wireless broadband modem to the router, and aggregating bandwidth from the wireless broadband modern interface and the wired wide area network interface.

The scope of the invention is defined by the claims, which are incorporated into this section by reference. A more complete understanding of embodiments of the present invention will be afforded to those skilled in the art, as well as a realization of additional advantages thereof, by a consideration of the following detailed description of one or more embodiments. Reference will be made to the appended sheets of drawings that will first be described briefly.

### BRIEF DESCRIPTION OF THE DRAWINGS

FIG. 1 illustrates an example system for providing aggregated bandwidth.

FIG. 2 illustrates an example bandwidth aggregation router in the system illustrated in FIG. 1.

FIG. 3 illustrates an example method for allocating aggregated bandwidth to a device or a plurality of devices.

Embodiments of the present invention and their advantages are best understood by referring to the detailed description that follows. It should be appreciated that like reference numerals are used to identify like elements illustrated in one or more of the figures.

### DESCRIPTION OF EXAMPLE EMBODIMENTS

Referring to PIG. 1, an example system 100 for aggregating and allocating bandwidth is illustrated. System 100 includes a bandwidth aggregation router 102 operably coupled to a wide area network (WAN) 110, such as the Internet, and a wireless network 112. Router 102 may be operably coupled to WAN 110 via a wired connection, such as DSL or cable. Router 102 may be operably coupled to wireless network 112 via a wireless broadband card 104 or a mobile handheld device that includes a wireless broadband modem.

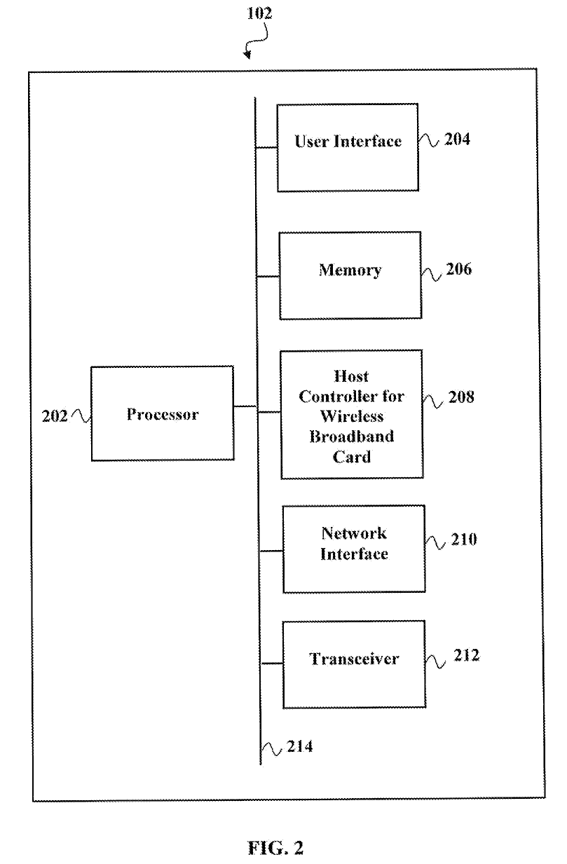

Router 102 may be any device that joins two networks together and serves as an entrance to a network, and in one example, router 102 allows wireless-equipped computers and other devices to communicate with a wired network. In a further example, router 102 may support wireless fidelity (WiFi) in general, and the IEEE 802.11 wireless networking standard in particular. Router 102 may also support the 10/100/1000 Base-T standards, automatic negotiation, and automatic MDIX. Router 102 is described in further detail below with respect to FIG. 2.

Wireless broadband card 104 may be a typical wireless broadband card commercially available from service providers such as Sprint and Verizon, for accessing respective wireless systems, such as a radio access network (RAN), CDMA, GSM, TDMA, WiMax, 3G, and 4G. In one example, wireless broadband card 104 includes a modem, and thus router 102 does not have to implement a complete modem functionality in this example. Instead, router 102 may include a hardware driver to configure and drive card 104, which may be implemented within a field programmable gate array (FPGA). The FPGA can be upgraded to newer versions of drivers or different drivers to support different mobile cards as well.

Devices that can access the WAN 110 or wireless network 112, such as computer 106a and laptop 106b, are operably coupled to bandwidth aggregation router 102 via a cable (e.g., computer 106a) or a wireless protocol (e.g., laptop 106b via WiFi). Computers 106a, 106b may include a variety of typical computers, and in one example is a typical personal computer including a general or special purpose processor, with network capabilities. In one example, computers 106a, 106b comprise a CPU, a memory, and a network adapter, which are interconnected by a bus. Other conventional means, such as a display, a keyboard, a printer, a bulk storage device, and a ROM, may also be connected to the bus. The memory stores network and telecommunications programs and an operating system (OS). The above-mentioned elements of computers 106a, 106b are well-known to the skilled person and commercially available. Other applicable devices that may access router 102 include but are not limited to PDAs, mobile telephones, and other mobile wireless devices that, have a wireless local area network (LAN) radio transceiver (e.g., wireless fidelity (WiFi), Bluetooth, ultra wideband (UWB) radio, etc.) for access to a public or private IP network (e.g., a wireless LAN or the Internet).

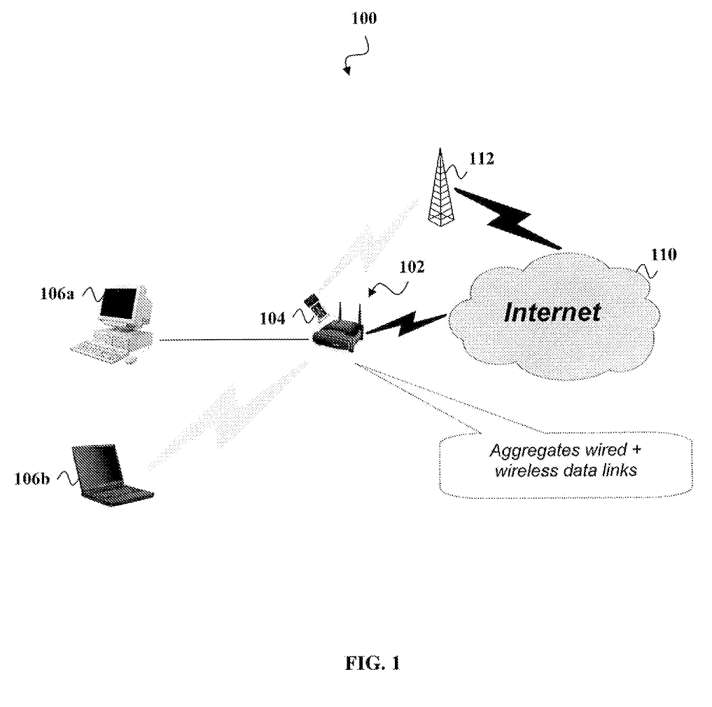

Referring now to FIG. 2 in conjunction with FIG. 1, a block diagram of an example of broadband aggregation router 102 is illustrated in accordance with a particular embodiment. Router 102 includes a processor 202 operably coupled via a bus 214 to: a user interface 204 via an input/output port; a memory 206 (e.g., SDRAM or flash memory) via a memory interface; a host controller 208 for coupling to a wireless broadband card via a compact flash (CF), secure digital input output (SDIO), a Universal Serial Bus (USB), or a peripheral component interconnect (PCMCIA) interface; a network interface 210 (e.g., a 10/100/1000 Base-T Ethernet port) via a MII interface; and a transmitter/receiver (transceiver) 212 via an input/output port.

Processor 202 is a high performance, highly integrated, and highly flexible system-on-chip (SOC) in one example. Processor 202 may include a variety of processors, with conventional CPUs being applicable. Processor 202 can aggregate the wide area network and wireless/cellular network links, and allocate the aggregated bandwidth using a network address translation (NAT) module, in one example, with other methods for load balancing being applicable as described at http://linas.org/linux/load.html. Processor 202 thus aggregates and efficiently allocates the aggregated bandwidth from the Internet service subscriptions available.

User interface 204 is operably coupled to processor 202 for displaying router functionality to the user, and in one example includes a light emitting diode (LED) system. In one example, LEDs may be used to indicate different functions or status of router 102. For example, an LED may be on when the apparatus is powered on and ready for use or off when the device is powered off. An LED may blink when the device is booting up or shutting down. An LED may also indicate connection to and/or operation with a LAW, a WAN, and/or broadband card. In one embodiment, firmware and hardware may be used in conjunction with the LED(s) to indicate status of the router, connection to and operation with the LAN, the WAN, and other functions of the router.

Memory 206 may include a variety of memories, and in one example includes SDRM and flash memory. As a further example, 32 MB of SDRAM by way of two 8 MB×16 SDR DRAM and 8 MB of flash memory by way of one 64 Mbits NOR type flash memory may be utilised. In one example, memory 206 may be used to store passwords and operating systems.

Host controller 208 acts as a wireless broadband modem interface and allows for communication between, processor 202 and wireless broadband card 104 or a mobile device including a wireless broadband modem. Host controller 208 is not limited to a single interface but may include various types of interfaces such as a compact flash (CF), secure digital input output (SDIO), a Universal Serial Bus (USB), or a peripheral component interconnect (PCMCIA) interface.

Network interface 210 provides for wired connection of router 102 to a LAN, and in one example supports the 10/100/1000 Base-T standards, automatic negotiation, and automatic medium dependent interface crossover (MDIX). In a further example, network interface 210 includes one or more Ethernet RJ-45 ports.

Transceiver 212 is a device that both transmits and receives/detects digital and/or analog signals, and in the context of the present invention is able to: 1) detect wireless signals from a wireless device requesting access to a network, 2) detect signals through a network wire and apply signals onto the network wire, and/or 3) transmit and receive signals from a carrier's wireless network. Transceiver 212 may include more than one transceiver in one example.

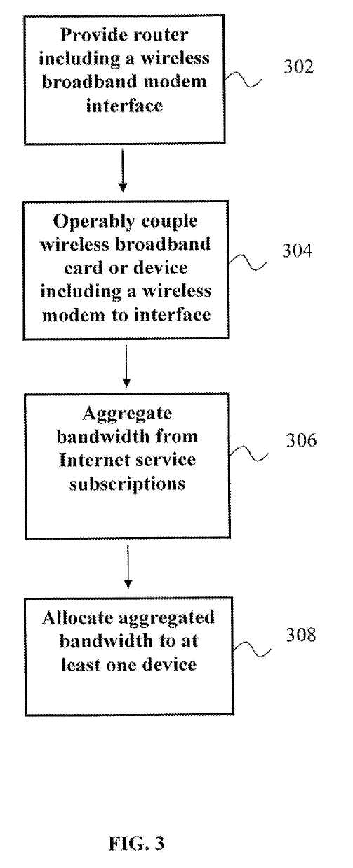

Referring now to FIG. 3 in conjunction with FIGS. 1 and 2, an example method for aggregating bandwidth and allocating aggregated bandwidth to a device or a plurality of devices is illustrated in accordance with a particular embodiment.

At step 302, a bandwidth aggregation router including a wireless broadband modem interface and a wired wide area network interface is provided. At step 304, a wireless broadband card or a mobile device including a wireless broadband modem is operably coupled to the modem interface of the router. At step 306, a processor in the router aggregates the bandwidth available from a wireless broadband subscription and a wired WAN subscription. At step 308, the processor allocates the aggregated bandwidth to at least one device for access to the Internet. Load balancing by the processor can be done by a NAT module, in one example, as described above.

Advantageously, particular embodiments of the present disclosure increase the overall available bandwidth to the Internet and allows for aggregated links to be shared by multiple users while not requiring changes to existing Internet subscriptions. Upload speeds are made higher and download throughput is increased while significantly improving a value to cost ratio.

Embodiments described above illustrate but do not limit the invention. It should also be understood that numerous modifications and variations are possible in accordance with the principles of the present invention. Accordingly, the scope of the invention is defined only by the following claims.

What is claimed is:

1. An apparatus, comprising:
a wireless broadband modem interface for communicating with a wireless network;
a wired wide area network interface; and
a processor configured to aggregate bandwidth from the wireless broadband modem interface and the wired wide area network interface.

2. The apparatus of claim 1, wherein the wireless broadband modem interface is capable of being operably coupled to a mobile broadband card or a handheld device including a wireless broadband modem.

3. The apparatus of claim 1, wherein the wireless broadband modem interface is selected from the group consisting of a compact flash (CF), a secure digital input output (SDIO), a Universal Serial Bus (USB), and a peripheral component interconnect (PCMCIA) interface.

4. The apparatus of claim 1, wherein the wireless network is selected from the group consisting of a radio access network (RAN), CDMA, GSM, TDMA, WiMax, 3G, and 4G.

5. The apparatus of claim 1, wherein the processor is further configured to allocate the aggregated bandwidth to at least one device.

6. The apparatus of claim 1, further comprising a transceiver for transmitting and receiving data from the wireless network.

7. The apparatus of claim 1, further comprising a transceiver for transmitting and receiving data from a device selected from the group consisting of a computer, a laptop, a PDA, a telephone, and a headset.

8. The apparatus of claim 1, wherein the apparatus supports the 802.11a, 802.11b, and/or 802.11g wireless networking standards.

9. The apparatus of claim 1, wherein the apparatus supports one of WiFi, Bluetooth, and ultra wideband (UWB).

10. An apparatus, comprising:
means for providing access to a wireless network;
means for providing access to a wired wide area network;
means for aggregating bandwidth to access the wireless network and the wired wide area network; and
means for allocating aggregated bandwidth to at least one device.

11. The apparatus of claim 10, wherein the means for providing access to a wireless network is capable of being operably coupled to a mobile broadband card or a handheld device including a wireless broadband modem.

12. The apparatus of claim 10, wherein the wireless network is selected from the group consisting of a radio access network (RAN), CDMA, GSM, TDMA, WiMax, 3G, and 4G.

13. The apparatus of claim 10, wherein the at least one device is selected from the group consisting of a computer, a laptop, a PDA, a telephone, and a headset.

14. The apparatus of claim 10, further comprising means for transmitting and receiving data from the wireless network.

15. A method, comprising:
providing a bandwidth aggregation router including a wireless broadband modem interface and a wired wide area network interface;
operably coupling a wireless broadband modem to the router; and
aggregating bandwidth from the wireless broadband modem interface and the wired wide area network interface.

16. The method of claim 15, wherein the wireless broadband modem is part of a mobile broadband card or a handheld device.

17. The method of claim 15, further comprising transmitting and receiving data from a wireless network via the wireless broadband modem.

18. The method of claim 17, wherein the wireless network is selected from the group consisting of a radio access network (RAN), CDMA, GSM, TDMA, WiMax, 3G, and 4G.

19. The method of claim 15, further comprising transmitting and receiving data from a device selected from the group consisting of a computer, a laptop, a PDA, a telephone, and a headset.

20. The method of claim 15, further comprising allocating aggregated bandwidth to at least one device.
